(19) United States
(12) Patent Application Publication
(10) Pub. No.: US 2026/0040279 A1
(43) Pub. Date: Feb. 5, 2026

(54) AIOT – RESOURCE ALLOCATION WITH MULTIPLE READERS

(71) Applicant: InterDigital Patent Holdings, Inc., Wilmington, DE (US)

(72) Inventors: Martino Freda, Laval (CA); Erdem Bala, East Meadow, NY (US); Paul Marinier, Brossard (CA); Jongwoo Hong, New York, NY (US); Brian Martin, Farnham (GB); Remun Koirala, London (GB); Ahmed Mostafa, Ottawa (CA); Aata EI Hamss, Laval (CA); Patrick Tooher, Montreal (CA)

(73) Assignee: InterDigital Patent Holdings, Inc., Wilmington, DE (US)

(21) Appl. No.: 18/794,781

(22) Filed: Aug. 5, 2024

(51) Int. Cl. H04W 72/044; G16Y 10/75; G16Y 40/30

(52) U.S. Cl. CPC H04W 72/044; G16Y 10/75; G16Y 40/30

(57) ABSTRACT

Procedures for ambient internet of things (AIoT) are disclosed herein. In an example, a wireless transmit/receive unit (WTRU) may receive a request message comprising a set of device identifications (IDs). The WTRU may send a report message indicating inventory parameters. The WTRU may receive an indication of an AIoT resource pool comprising information indicating time-frequency resources for transmission and reception of ambient Internet-of-things (AIoT) signals and linkage information for the resources. On a condition that the WTRU is configured to be a transmitting WTRU, the WTRU may transmit, to an AIoT device, the information indicating the inventory parameters, and an occasion synchronization message using a time-frequency resource for transmission of AIoT signals. The WTRU may receive, from the AIoT device, a message indicating a random identification (ID) for the AIoT device using linked resources.

### BACKGROUND

In recent years, Internet of Things (IoT), in which physical devices or “things” typically embedded with sensors and software are interconnected to collect and share data, has attracted attention in the wireless communication community. Influenced by the increased popularity of IoT, 3GPP has agreed to a study item on Ambient Internet of Things (AIoT), which may include large numbers of interconnected devices, and where devices may be powered by harvesting energy from ambient sources (e.g., radio waves, light, motion, heat) to support low maintenance operation. For example, a transmitted carrier wave (CW) may be used as an energy source to energize AIOT devices that rely on an external energy source to perform their own operation (e.g., backscattering). More devices or things are expected to be interconnected for improving productivity and efficiency and increasing comforts of life. Further reduction of size, complexity, and power consumption of IoT devices can enable the deployment of tens of billions or even hundreds of billion IoT devices for various applications and provide added value across the entire value chain. At that scale, battery-powered IoT devices that need to be replaced or recharged manually results in high maintenance cost, serious environmental issues, and potentially safety hazards in some use cases (e.g., wireless sensor in electric power and petroleum industry).

Considering the limited size and complexity required by practical applications for battery-less devices with no energy storage capability or devices with limited energy storage that do not need to be replaced or recharged manually, the output power of an energy harvester is typically in the range of 1 μW to a few hundred μW. Existing cellular devices may not work well with energy harvesting due to their peak power consumption of 10 mW or higher.

### SUMMARY

Procedures for ambient internet of things (AIoT) are disclosed herein. In an example, a wireless transmit/receive unit (WTRU) may receive, from a network node, a request message comprising a set of device identifications (IDs), wherein the request message is one of an inventory request message and a command request message. The WTRU may send, to the network node, a report message comprising information indicating inventory parameters. The WTRU may receive, from the network node, an indication of an AIoT resource pool comprising information indicating time-frequency resources for transmission of ambient Internet-of-things (AIoT) signals and time-frequency resources for reception of AIoT signals and a linkage between the time-frequency resources for the transmission of the AIoT signals and the time-frequency resources for the reception of the AIoT signals. On a condition that the WTRU is configured to be a transmitting WTRU, the WTRU may transmit, to an AIoT device, the information indicating the inventory parameters using at least one resource from the indicated time-frequency resources for transmission of AIoT signals. The WTRU may transmit, to the AIoT device, an occasion synchronization message using the at least one resource from the indicated time-frequency resources for transmission of AIoT signals. The WTRU may receive, from the AIoT device, a message indicating a random identification (ID) for the AIoT device using at least one resource from the indicated time-frequency resources for reception of AIoT signals that is linked to the at least one resource from the indicated time-frequency resources for transmission of AIoT signals according to the indicated linkage between the time-frequency resources for the transmission of the AIoT signals and the time-frequency resources for the reception of the AIoT signals.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a signaling diagram illustrating an example inventory procedure 200 for RFID between one or more RFID tag(s) and an interrogator;

FIG. 3 is a signaling diagram illustrating an example random access procedure in AIoT;

FIGS. 4A-4E are system diagrams illustrating different example AIoT network topologies;

FIG. 5 is a system diagram illustrating an example AIoT network illustrating a bi-static scenario;

FIG. 6 is a signaling diagram illustrating an example joint inventory procedure performed by a WTRU; and

FIG. 7 is a signaling diagram illustrating an example inventory procedure involving multiple readers.

### DETAILED DESCRIPTION

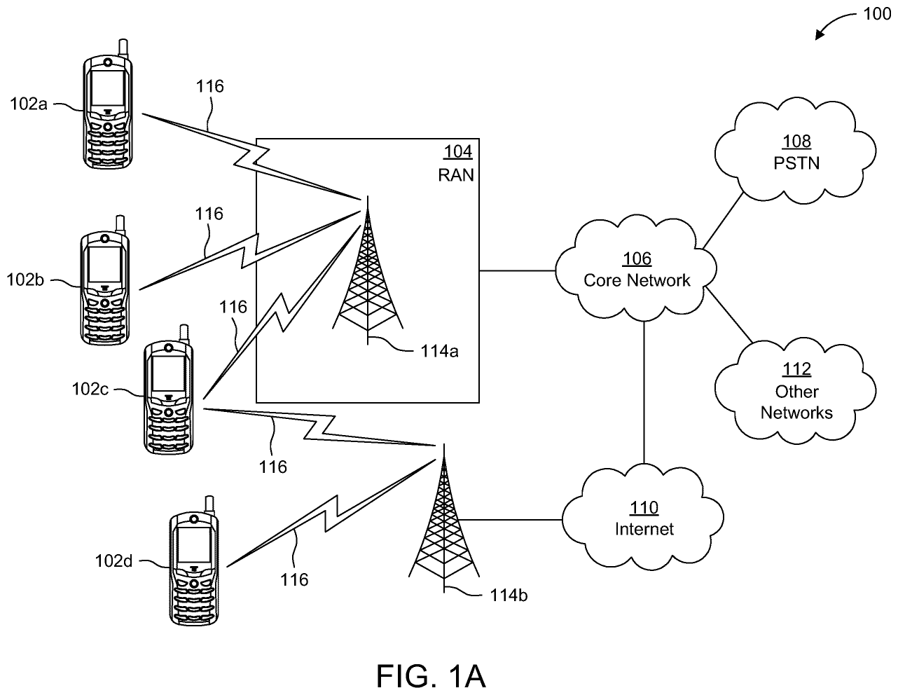

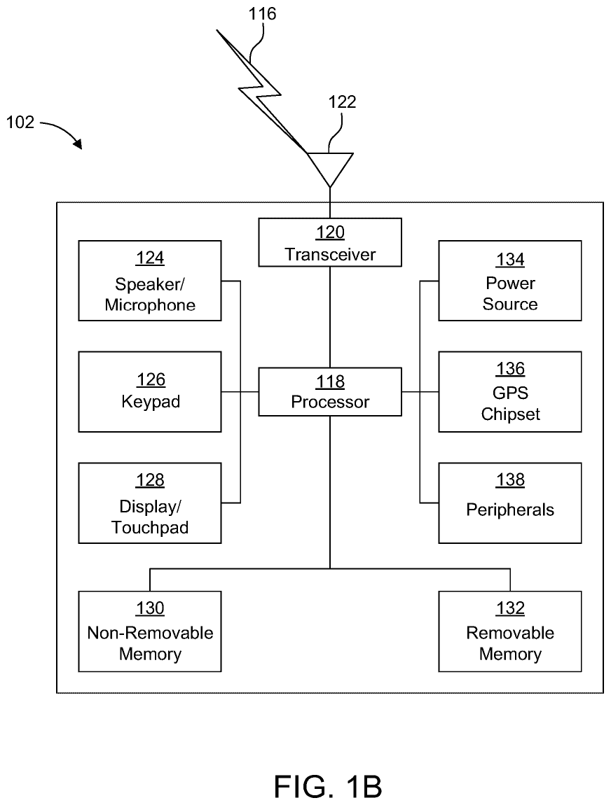

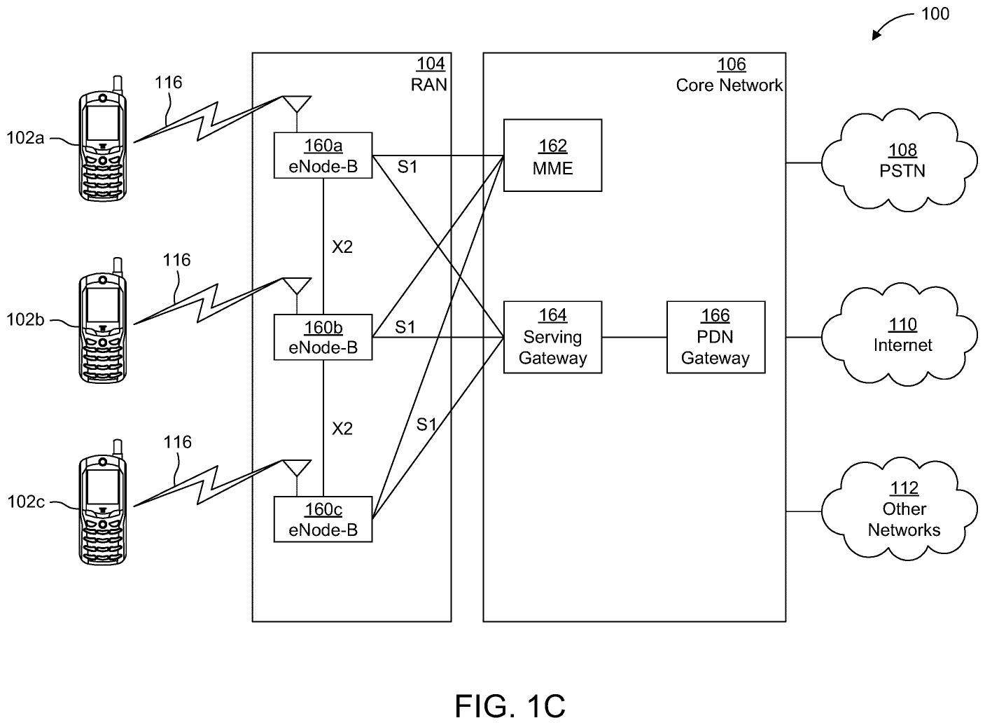

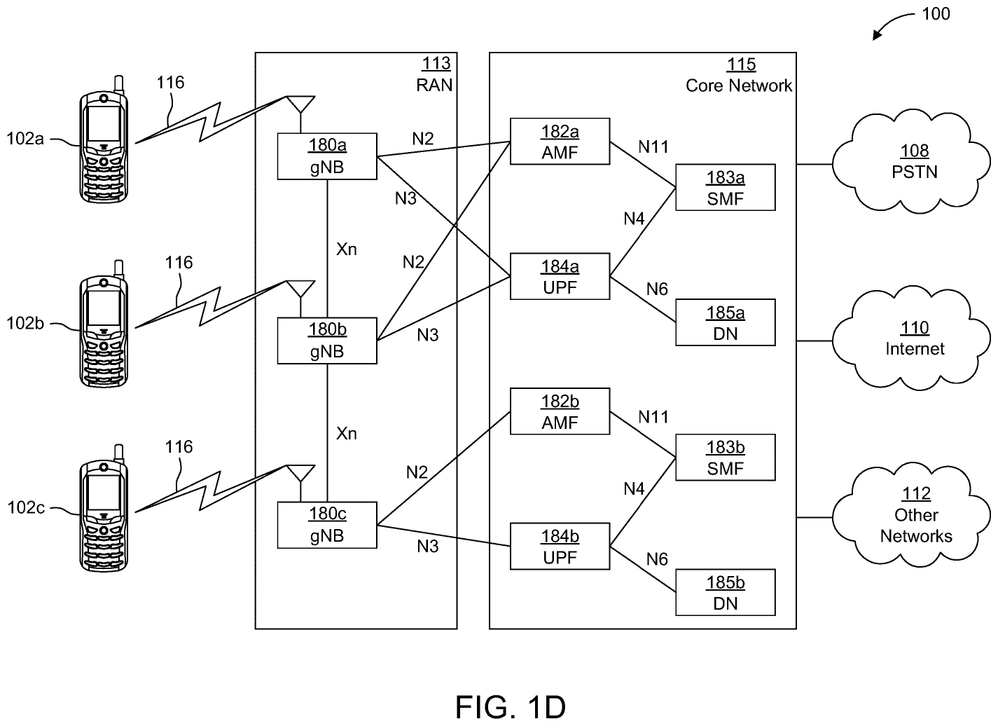

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Example embodiments for IoT and/or Ambient IoT (AIoT) networks are disclosed herein. Example embodiments are directed to IoT/AIoT resource allocation, IoT/AIoT resource format, network signaling to schedule transmission on an IoT/AIoT resource, network signaling to schedule reception on an IoT/AIoT resource, and network signaling to schedule both transmission and reception resources on IoT/AIoT, which may be associated with different transmission/reception types; dynamic network-triggered transmission. Further example embodiments are directed to resource configuration for AIoT reader, a reader determining a subset of configured resources used or restricted for its own transmission or reception, a reader indicating the selected resource(s) (or subset) to the network, a reader being associated with a role specific to an AIoT procedure, a reader determining its role, and synchronizing multiple transmissions from different readers at the device.

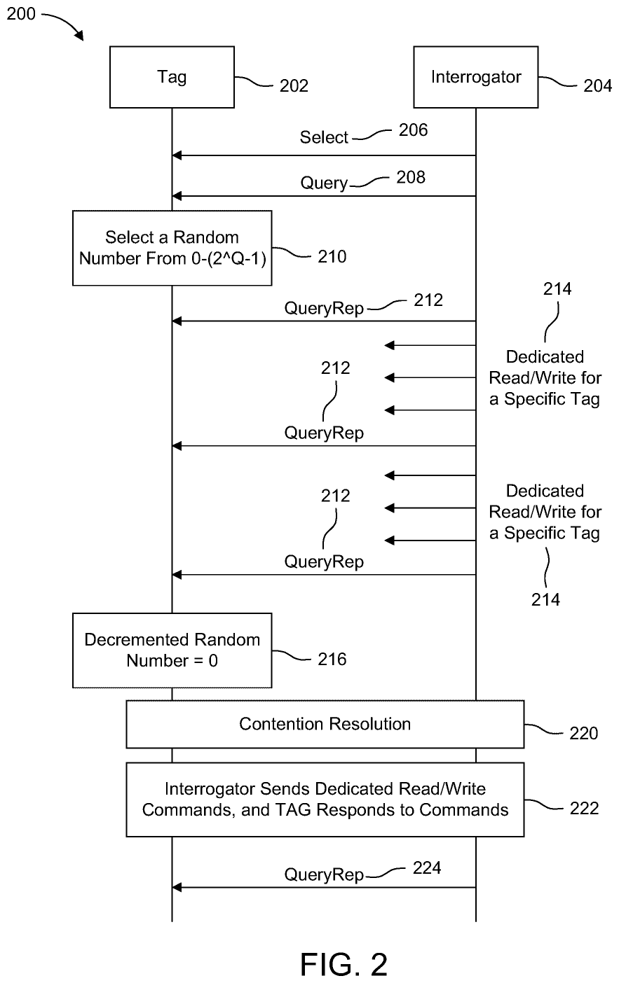

Radio frequency identification (RFID) and associated RFID procedures may be used for applications of asset identification. FIG. 2 is a signaling diagram illustrating an example inventory procedure 200 for RFID between one or more RFID tag(s) 202 and an interrogator 204. According the example inventory procedure 200, interrogator 204 may send a select message 206 to tag(s) 202 in order to select a subset of the tag(s) 202 that may be involved in the inventory procedure 200. Interrogator 204 may send a query message 208 to one or more tags, including tag 202, to energize all or a subset of the one or more tags (e.g., tags other than tag 202 not shown). In response to reception of query message 208, tag 202 may at 210, select a random number, for example an integer number between 0 and 2^{Q-1} (e.g., 2^{Q-1} may refer to the number of access occasions and hence the number of QueryRep messages) and load its memory with the selected random number as a counter. Interrogator 204 may send QueryRep messages 212 to the tags including tag 202 to initiate an access occasion and to cause tags 202 with counters to decrement their counter by 1. Interrogator 204 may perform dedicated read/write operations 214 for specific tags including tag 202 under certain conditions.

For example, at each transmission of QueryRep message 212 from the interrogator 204, tag 202 may decrement its counter (random number) until the counter reaches 0. At 216 when the decremented counter (random number) reaches 0, the tag 202 may initiate a contention resolution procedure 220, which may consist of the tag 202 transmitting its device ID towards the reader, and waiting for confirmation of the device ID from the reader. Contention resolution procedure 220 may serve to address possible collision between multiple tags (devices) selecting the same random number. In the case that tag 202 passes contention resolution procedure 220, then read/write exchanges 222 may occur, in which the interrogator 204 may send one or more dedicated read/write commands to tag 202 and tag 202 may send response(s) to the interrogator 204 in response to the dedicated read/write commands.

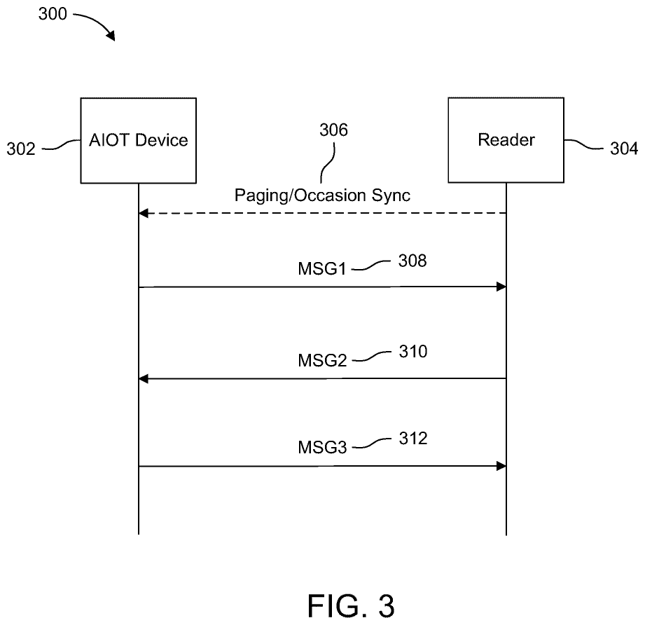

FIG. 3 is a signaling diagram illustrating an example random access procedure 300 in AIoT. Random access procedure 300 in AIoT may occur between an AIoT device 302 and a reader device 304 after AIoT device 302 has determined its transmission occasion based on paging and/or occasion synchronization (sync) message 306 from reader 304. The occasion sync message 306 may also be referred to herein as the sync message or sync/occasion message and is the message that synchronizes or determines the start of an occasion. AIoT device 302 may transmit a random ID in MSG1 308 to reader 304. Reader 304 may send a response (echo back) with random ID in MSG2 310 to AIoT device 302. AIoT device 302 may send its device ID and/or application layer data in MSG3 312 to reader 304.

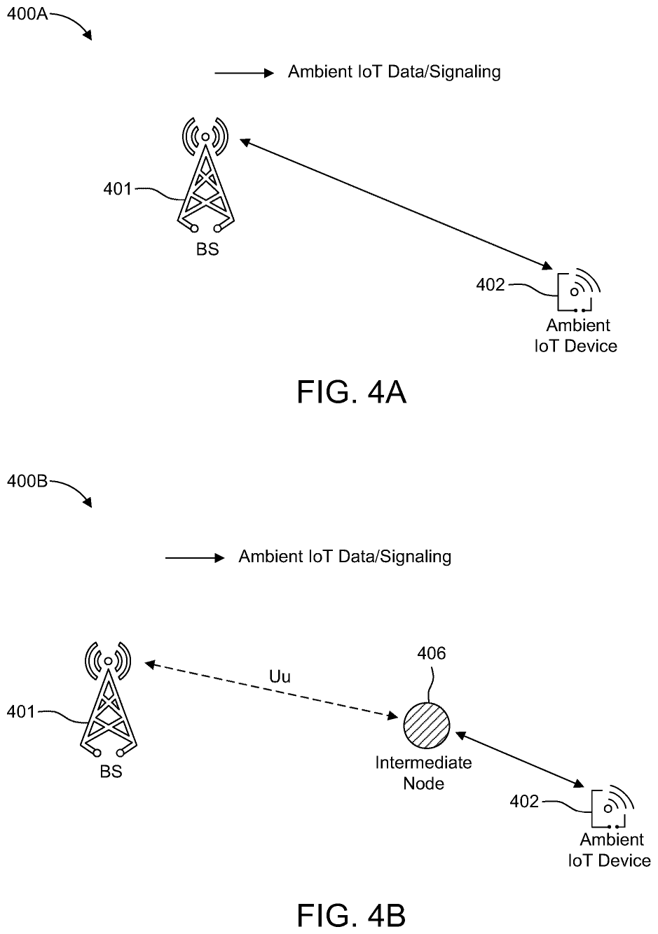

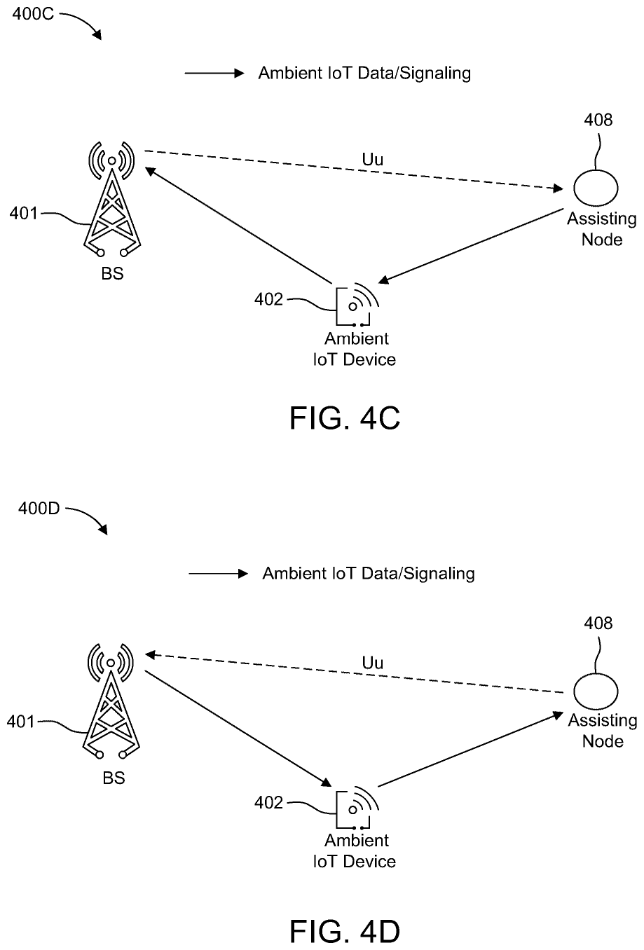

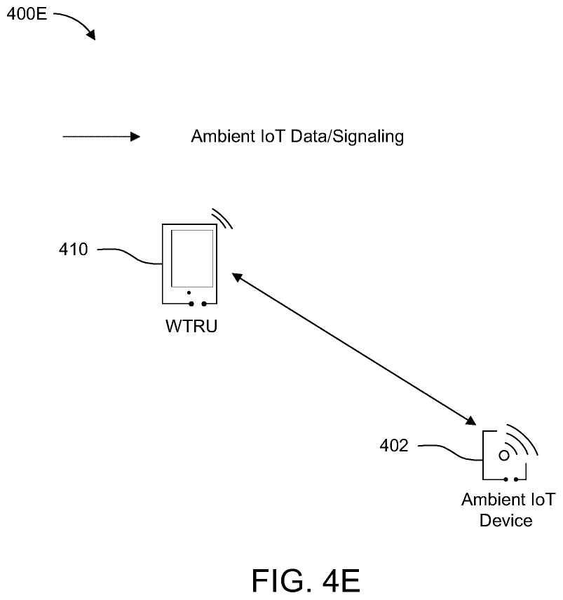

FIGS. 4A-4E are system diagrams illustrating different example AIoT network topologies 400A-400E. FIG. 4A is a system diagram illustrating example topology 400A between base station (BS) 401 and AIoT device 402. According to example topology 400A, AIoT device 402 directly and bidirectionally communicates with BS 401. The communication between the BS 401 and the AIoT device 402 may include AIoT data and/or signaling. Example topology 400A may be modified such that that BS 401 transmits to AIoT device 402 and a different BS (not shown) receives from the AIoT device 402. FIG. 4B is a system diagram illustrating example topology 400B between BS 401, intermediate node 406 and AIoT device 402. According to example topology 400B, AIoT device 402 communicates bidirectionally via an intermediate node 406 in order to communicate with BS 401. For example, intermediate node 406 may be, but is not limited to, any of the following devices that is capable of AIoT: a relay, an integrated access/backhaul (IAB) node, a WTRU (UE), and/or a repeater. Intermediate node 406 may transfer or relay the information between BS 401 and the AIoT device 402.

FIG. 4C is a system diagram illustrating example topology 4000 between BS 401, assisting node 408 and AIoT device 402, in which assisting node 408 provides downlink assistance. According to example topology 400A, AIoT device 402 may transmit data/signaling to BS 401, and may receive data/signaling from assisting node 408. For example, assisting node 408 may be, but is not limited to, any of the following devices that is capable of AIoT: a relay, an IAB, a WTRU (UE), and/or a repeater. FIG. 4D is a system diagram illustrating example topology 400D between BS 401, assisting node 408 and AIoT device 402, in which assisting node 408 provides uplink assistance. According to example topology 400A, AIoT device 402 may receive data/signaling from BS 401, and may transmit data/signaling to assisting node 408. For example, assisting node 408 may be, but is not limited to, any of the following devices that is capable of AIoT: a relay, an IAB, a WTRU (UE), and/or a repeater. FIG. 4E is a system diagram illustrating example topology 400E between WTRU 410 and AIoT device 402. According to example topology 400E, AIoT device 402 may communicate bidirectionally with a WTRU 410. The communication between WTRU 410 and the AIoT device 402 may include AIoT data and/or signaling.

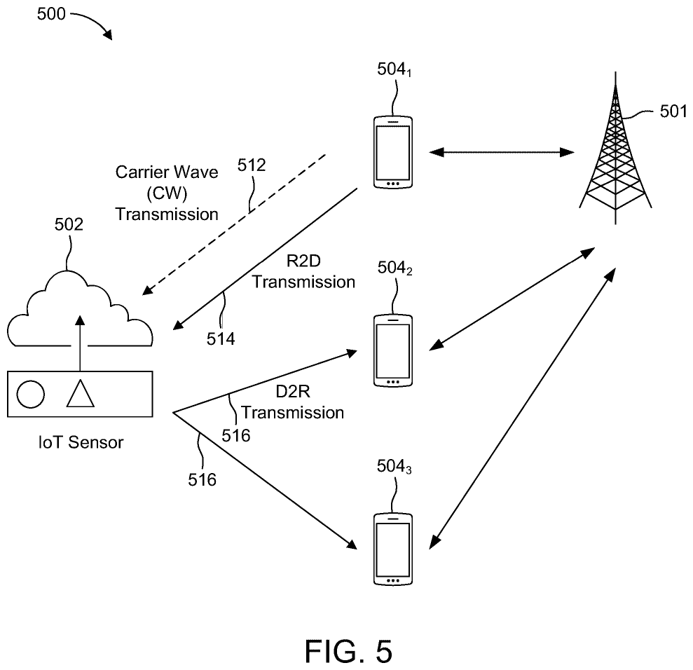

For example topology 400B as illustrated in FIG. 4B, multiple readers may be under the control of the same BS/gNB 401. In this case, when the core network initiates an inventory procedure on IoT/AIoT devices, it may be more efficient to perform said inventory procedure cooperatively between multiple (2 or more) readers, in order to avoid redundant transmissions by multiple readers in different resources. For example, a cooperative inventory procedure may be accomplished by dividing the set of AIoT devices between the different readers, rather than having each reader trigger the inventory on all of the devices. Another consideration for IoT/AIoT systems is support of bi-static cases. A transmitted carrier wave (CW) may be used as an energy source to energize an AIoT device 402 in the case that the AIoT device 4021 relies on an external energy source to perform its own operation(s). According to a bi-static case, a reader that transmits the carrier wave (CW) is different from the reader that performs reception of (AIoT) device data. The bi-static case may handle the scenario where some readers experience too much interference when performing transmission of CW and reception of data simultaneously. It is therefore possible that a reader that transmits during an inventory procedure (e.g., the initiator of the inventory procedure) may not perform reception of data from the AIoT device, as illustrated in FIG. 5.

FIG. 5 is a system diagram illustrating an example AIoT network 500 illustrating a bi-static scenario. Example AIoT network 500 includes AIoT device 502, base station 501, and intermediate nodes that operate as readers 504₁, 504₂, 504₃ and enable communication between the AIoT device 502 and the base station 501. In this example, reader 504₁ may transmit CW 512 to AIoT device 502, and may send reader-to-device (R2D) downlink transmission 514 to AIoT device 502, but may not receive device-to-reader (D2R) uplink transmissions from AIoT device 502. AIoT device 502 may send D2R uplink transmissions 516 to readers 504₂, 504₃. To support cases like the example bi-static illustrated in FIG. 5, coordination may be used between the readers (e.g., readers 504₁, 504₂, 504₃) to handle and exchange information regarding the resources to be used for AIoT communication and whether to use the resources for transmission (TX) and/or reception (RX), and to handle and exchange information needed by each of the readers (e.g., readers 504₁, 504₂, 504₃) to successfully perform the inventory procedure and/or command procedure in a coordinated fashion. Thus, an issue addressed by the example embodiments disclosed herein is how to manage the resources and share information needed to perform an AIoT operation (e.g., inventory procedure, command procedure) jointly among multiple intermediate nodes acting as AIoT readers.

The following terminology may be used to describe the example embodiments disclosed herein. In the example embodiments disclosed herein, the terms device, AIoT device, AIoT WTRU (or simply WTRU), AIoT UE (or simply UE), and tag may be used interchangeably to mean an AIoT device, for example an AIoT device that is being inventoried/queried by a reader. The term reader may refer to the device and/or entity that queries the AIoT device, either directly, or via an intermediate node (e.g., intermediate node 406 in FIG. 4B). A reader may be a WTRU or a network node. As a result, the term reader may refer to a network node or a WTRU, depending on the context and/or the topology. The term reader may also be referred to as an intermediate node, an intermediate WTRU (or simply WTRU), or an intermediate UE (or simply UE). In the example embodiments disclosed herein, the terms reader, network, intermediate WTRU, or WTRU may be used interchangeably to refer to a reader. In the example embodiments disclosed herein, network may be used interchangeably with base station (BS), gNB, and network node to represent generally any entity that serves as an interface for communication between one or more WTRUs (e.g., readers) and a communication network, which may include a core network.

In the example embodiments disclosed herein, inventory may refer an the overall procedure of a reader triggering access by one or more devices using a sequence of messages (e.g., query message and query rep message(s) in an RFID procedure). In an example, an inventory procedure may refer to a round of attempts to have each device (e.g., an IoT/AIoT device) respond or attempt to respond with to a reader with the device's own access ID, or perform a random access procedure. In an example, the inventory procedure may refer to a set of access occasions which may have 0 or at least 1 device respond within the access occasion. In the example embodiments disclosed herein, inventory procedure may be termed differently, for example depending on device requirements and/or specifications. For example, query procedure and/or paging procedure may be used interchangeably with inventory procedure.

In the example embodiments disclosed herein, occasion may refer to an opportunity for a device transmission that may be delimited by the transmission of query rep messages or similar message (e.g., the occasion is the period of time that occurs between the transmission of sync or query rep messages). For example, a device may perform transmission in an occasion by performing an AIoT transmission in a defined period of time following reception of a query rep message associated with the AIoT transmission. In another example, an occasion may consist of both a time aspect and a frequency aspect. For example, a device may determine an occasion as a transmission following reception of a specific query rep message, and by transmitting on one of a number of frequencies (e.g., frequency division multiplexing (FDM)). Example embodiments that indicate selection of an occasion may apply equivalently to selection of a time component and/or selection of a frequency component. An AIoT transaction as disclosed herein may include, but is not limited to, any of the following procedures in the context of AIoT: an inventory procedure, and inventory-plus-command procedure, a command procedure, and/or or a random access procedure.

In certain example embodiments disclosed herein, reference to time may be associated with an absolute time measurement (e.g., seconds, slots, frames). In certain example embodiments disclosed herein, reference to time may refer to a number of executions of a procedure, which may or may not be triggered by a reader (e.g., number of inventory procedures, number of accesses or RACH procedures). In certain example embodiments disclosed herein, reference to time may refer to a number of messages, possibly of a specific type, or containing specific information, as described herein, received or transmitted.

In the example embodiments disclosed herein, configuration or pre-configuration may refer to any configuration received by a message (e.g., an radio resource control (RRC) message, a medium access control (MAC) control element (CE), a physical (PHY) layer signal, a data protocol data unit (PDU), and/or a control PDU, any of which may be associated with any or a new protocol layer). Configuration may be received by a (AIoT) device in a message from a network node or another device such as a WTRU. In the example embodiments disclosed herein, a device may be configured by a reader, such that the reader may be a network node or a WTRU (e.g., intermediate node 406 in FIG. 4B). In the case that the reader is a WTRU, the reader/WTRU may derive the device configuration itself, or receive the device configuration from the network, in which case the reader/WTRU may act as an intermediate node to relay the device configuration from the network to the device. In another example, a device configuration (in the case of a device 402 in FIG. 4B) may be received by a WTRU from a network node (e.g., the BS/gNB 401 in FIG. 4B), and the WTRU may transmit the device configuration to the device (e.g., in another form).

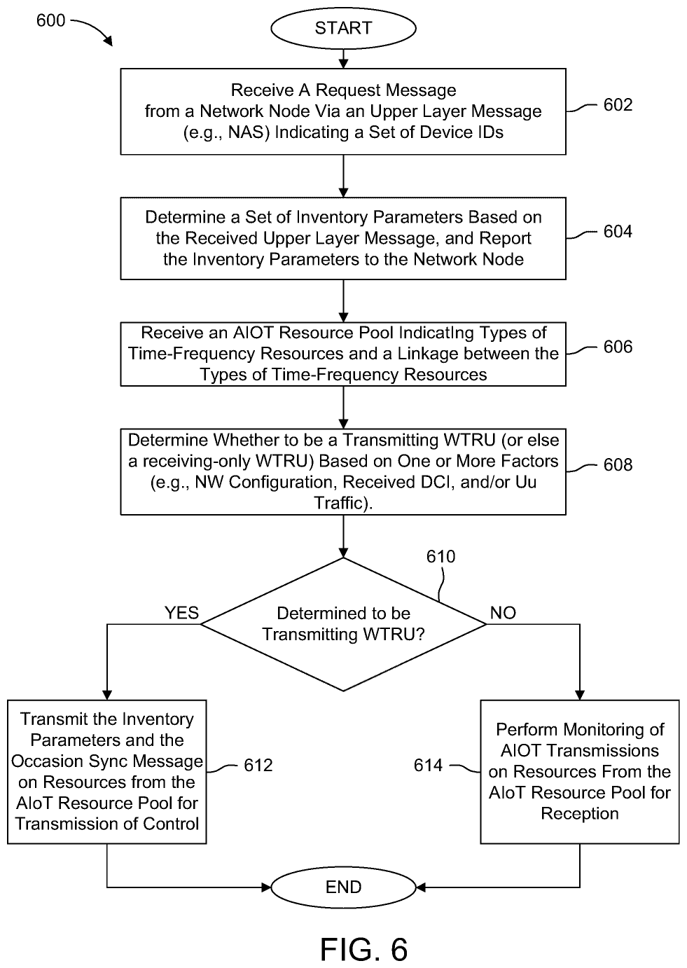

In an example embodiment for resource management for AIoT operations coordinated among multiple intermediate nodes acting as AIoT readers, a WTRU (or other type of intermediate node) may determine whether to be a transmitting reader and/or receiving reader in a joint inventory procedure performed on a set of configured resources based on network scheduling. Based on the WTRU's decision, the WTRU may transmit and/or receive the random access step results to/from the network. FIG. 6 is a signaling diagram illustrating an example joint inventory procedure 600 performed by a WTRU, where the WTRU may be an AIoT reader. The WTRU may be for example intermediate node 406 in the example topology 400B of FIG. 4B.

With reference to FIG. 6, at 602, the WTRU (as an intermediate node) may receive an inventory request and/or command request from the network (e.g., the CN via a BS/gNB). The inventory and/or command request may be an upper layer message (e.g., network access stratum (NAS)) and may include a set of device identifications (IDs). At 604, the WTRU may determine a set of inventory parameters (e.g., number of access rounds, device ID(s)) based on the received upper layer message and report the determined set of inventory parameters to the BS/gNB (e.g. using an RRC message). For example, the WTRU acting as an intermediate node (reader) may be (pre)configured with inventory parameters to use for each range of the number of device IDs indicated in the received inventory request. At 606, the WTRU may receive (e.g., in an RRC message) information indicating an AIoT resource pool (e.g., a set of associated resources for transmission and reception of AIoT signals/messages in time/frequency), which may indicate a set of time-frequency resources for transmission of AIoT signals (on the AIoT interface) and time-frequency resources for reception of AIoT signals (on the AIoT interface) and an indication of a linking or linkage between the time-frequency resources for the transmission of the AIoT signals and the time-frequency resources for the reception of the AIoT signals (e.g., an association between resources that are used for different purposes such as transmitting AIoT signals and receiving AIoT signals). For example, the linkage of the resources may be for each of the following: transmission of control information (e.g., paging message, occasion sync message); an associated reception of a message indicating a random ID (e.g., MSG1); an associated transmission of a message echoing the random ID (e.g., MSG2); and an associated reception of device data.

At 608, the WTRU may determine whether to be configured as a transmitting WTRU. For example, the WTRU may determine whether to be configured as a transmitting WTRU (at 608) based on any one or more of the following factors: network configuration, dedicated downlink control information (DCI), and/or Uu traffic. For example, the WTRU may determine to be configured as a transmitting WTRU in the case that receiving transmission resources are indicated in the received resource pool. In another example, the WTRU may determine to be configured as a transmitting-WTRU at 608 based on a received indication from the network (e.g., DCI) prior to the configured transmission resources. In another example, the WTRU may determine to be configured as a transmitting WTRU in the case that the WTRU does not have Uu transmissions that overlap with any transmission resources in the received resource pool.

If the WTRU determines that it is a transmitting WTRU (610), then at 612, the WTRU may transmit, to an AIoT device, the inventory parameters (e.g., device ID, Q) and the occasion sync message on at least one resource (e.g., a resource for transmission of control) determined from the AIoT resource pool. For example, the WTRU may determine or select (e.g., randomly) from the AIOT resource pool one or more resource(s) for transmission of AIoT signals. The WTRU may determine or select one or more resource(s) for transmission of control from the subset of resources selected for transmission of AIoT signals (e.g., occasion sync message) from the AIoT resource pool. Subsequent reception by the WTRU from the AIoT device on the AIoT interface may use linked resources according to the indicated linkage information (not shown). For example, the WTRU may receive, from the AIoT device, a message indicating a random ID for the AIoT device (e.g., MSG1) using at least one resource from the indicated time-frequency resources for reception of AIoT signals that is linked to the at least one resource from the indicated time-frequency resources for transmission of AIoT signals according to the indicated linkage between the time-frequency resources for the transmission of the AIoT signals and the time-frequency resources for the reception of the AIoT signals (not shown). If the WTRU determines that it is not a transmitting WTRU and is thus a receiving-only WTRU (610), then at 614 the WTRU may perform monitoring of AIoT transmissions on the resources associated with MSG1 reception from the AIoT resource pool.

Subsequent steps not shown in FIG. 6 may include any of the following. In an example, upon reception of one or more (random) ID(s) (e.g., an ID indicated in MSG1) on the resources for MSG1 reception, or reception of a device ID from the network (e.g., in DCI containing the device ID), a WTRU that is a transmitting WTRU may transmit the received random ID on the associated resource for transmission of MSG2. A WTRU that is a receiving WTRU may send the received device ID to the network (e.g., in a scheduling request (SR) or buffer status report (BSR)). The WTRU that is a receiving WTRU may perform reception of the application device ID on the associated resource for device ID reception. When completing the monitoring on all reception resources of the resource pool, the WTRU that is a receiving WTRU may send a report to the network with the received device data in MSG3 (e.g., containing device ID, AIoT received power, carrier frequency/characteristics).

Example embodiments, any of which may be used with any of the procedures described herein including example joint inventory procedure 600, are described in the following. Example procedures may be directed to resource configuration and/or resource allocation for a reader. Example embodiments are directed to AIoT resource formatting. With regard to AIoT resource format, for the configuration of resources used for inventory and/or command by multiple readers, multiple readers may be controlled by the network (e.g., BS/gNB) to ensure the resources can be shared adequately. In an example, for resources meant for transmission on the AIoT interface, a reader may receive dedicated resources from the network. For resources meant for reception on AIoT, a reader may receive shared or dedicated resources from the network. A resource on the AIoT interface may be configured or indicated in reference to a Uu resource. For example, the time base of an AIoT resource may use the Uu slot. Specifically, assignment of one or more consecutive slots using the Uu time-base may refer to the period of time in which the reader may perform transmission or reception on the AIoT interface.

In an example, a resource on AIoT may be configured or indicated using a maximum duration associated with a fixed number of slots. Specifically, the network may allocate a resource for transmission, and the reader may perform the transmission in a shorter period of time. The reader may perform the transmission in any time window on AIoT that fits in the allocated maximum time duration. A resource on AIoT for transmission/reception of a message may be configured to use a single AIoT frequency (e.g., using FDM) or using multiple frequencies. Whether a single or multiple frequencies are used for transmission of a message may depend on the message type and which entity is transmitting on AIoT. For example, reader transmissions may occupy multiple/all frequencies while device transmissions may occupy a single frequency, thus allowing multiple devices to transmit simultaneously on different resources. In another example, multiple message transmissions may be made by one or more readers on different frequencies and message transmission by devices may occupy all frequencies.

In an example, a resource allocated by the network (e.g., using resource allocation procedures described herein) may be allocated in a persistent manner, and for a finite number of periods. For example, the network may allocate Q sync transmission resources (i.e., resources for transmitting occasion sync messages), where Q indicates the number of occasions in the inventory procedure (e.g., which may be decided by the reader or network). A reader may perform transmission on each of the next Q configured occasion sync resources following the assignment. In another example, the network may assign a maximum number of resources (e.g., Qmax), and the reader may decide the number used for the inventory procedure. Upon completion of the inventory procedure, or prior to it, the reader may indicate the resources required/released to the network (e.g., based on whether the reader determines that further occasions are required for the inventory procedure).

Example embodiments are directed to network signaling to schedule transmission on an AIoT resource. For example, a reader may receive scheduling information (e.g., via DCI) that allocates resources for AIoT transmission. Scheduling may consist of any example of network signaling (e.g., DCI, MAC CE, RRC), and a scheduling DCI is assumed in the following for illustrative purposes. A scheduling DCI may explicitly indicate the AIoT resource timing with reference to the Uu timing of one or multiple Uu resources (e.g., transmit on the AIoT resource for at most the time duration of x slots). The scheduling DCI may explicitly indicate an index of an AIoT resource (time and/or frequency) within a configured set of AIoT resources (e.g., received by RRC). The scheduling DCI may explicitly indicate the type of message to transmit (e.g., paging message, occasion sync message, MSG2). The scheduling DCI may contain parameters (e.g., resources, number of occasions) to be included in the AIoT transmission. For example, the scheduling DCI may include the number of AIoT occasions associated with the inventory procedure which may have been triggered at the reader. For example, the scheduling DCI may contain the random number to be transmitted by the reader as MSG2. The reader may initiate a Uu message transmission upon an inventory procedure and receive a scheduling DCI that initiates AIoT transmission. The scheduling DCI may enable a specific AIoT transmission (e.g., paging, occasion synchronization transmission, MSG2, command) at the reader based on the indication of the AIoT resource in the received scheduling DCI. For example, if the scheduling DCI indicates an occasion sync message resource, the reader may transmit a sync message on the AIoT interface. In another example, if the DCI indicates a MSG2 resource, the reader may transmit MSG2 (i.e., echo of a random ID) on the indicated resource.

Example embodiments are directed to network signaling to schedule reception on an AIoT resource. For example, a reader may receive scheduling information (e.g., in DCI) that indicates resources for AIoT reception. Scheduling may consist of any example of network signaling (e.g., DCI, MAC CE, RRC), and a scheduling DCI is assumed in the following for illustrative purposes. For example, a DCI may indicate any of the starting slot, ending slot, AIoT frequency, duration, and/or a resource index (referring to an RRC configuration of resource sets) in which the reader should monitor and decode the AIoT interface. For example, a DCI may indicate a resource index within a configured pool of resources previously received by the reader. For example, the reader may receive a resource pool, possibly with resources associated with different transmission and/or reception types. The reader may perform monitoring/reception on an AIoT resource of a given type if it receives a scheduling DCI that occurs at some time (e.g., configured or defined) prior to the AIoT reception resource. In another example, a reader may receive an RRC message with a set of resources to monitor for a device transmission (e.g., MSG1 transmissions). In the examples described herein, such signaling may also configure an event at the reader for reporting based on the specific device transmission (e.g., MSG1 or MSG3).

Example embodiments are directed to network signaling to schedule both transmission and reception resources on AIoT, and may be associated with different transmission/reception types. For example, a reader may receive scheduling information (e.g., in a DCI) that indicates resources for both AIoT transmission and reception. Transmission and reception resources may be associated with each other (e.g., command and response). Scheduling may consist of any example network signaling (e.g., DCI, MAC CE, RRC), and a scheduling DCI is assumed in the following for illustrative purposes. For example, a single DCI may schedule a transmission by an AIoT reader followed by the subsequent reception by one or more devices in response to the AIoT reader transmission. Specifically, an AIoT reader, upon reception of a DCI from a network node, may perform AIoT transmission for a first period of time, followed (e.g., immediately or after a delay) by AIoT reception for a second time period. The scheduling DCI may further define the format of the transmission/reception resources, either explicitly, or based on indication of configured or predefined formats. Examples indications of format for transmission/reception resources may include, but is not limited to, any of the following example indications of format.

An example indication of format for transmission/reception resources may indicate frequenc(ies) over which to perform transmission and/or transmission FDM format. Another example indication of format for transmission/reception resources may indicate frequency(ies) over which to perform reception following transmission and/or reception FDM format. For example, a single AIoT reader transmission over multiple frequencies may be associated with multiple (e.g., different) AIoT reception resources each over one of the multiple frequencies, and each may contain a transmission from a distinct device. Another example indication of format for transmission/reception resources may indicate a time duration of the transmission/reception on AIoT (e.g., in terms of absolute time, or in terms of Uu slots). The indication of time duration may include indication of a minimum time or maximum time. For example, a reader may monitor for the duration of a maximum time, or until reception on the AIoT interface within that maximum time. Another example indication of format for transmission/reception resources may indicate transmit power or allowable range of transmit power. Another example indication of format for transmission/reception resources may indicate other physical layer parameters for transmission on AIoT, such as preamble sequence, midamble sequence, and/or postamble sequence (and whether to include them). Other physical layer parameters for transmission may be signaled in terms of a (pre)configured or predefined transmission format.

In another example of network signaling to schedule both transmission and reception resources on AIoT, a single DCI may be used to allocate AIoT resources for a specific combination of transmission type followed by reception type (where type is defined herein), where such combination may be predefined, or configured. The DCI may include as part of its contents an indication of an allocation of AIoT resources for a specific combination of transmission type followed by reception type. In an example of an indication of an allocation of AIoT resources for a specific combination of transmission type followed by reception type, a first DCI type may allocate an AIoT transmission resource that allows transmission of sync/occasion signal(s) followed by reception of one or more (e.g., in different frequencies) MSG1 reception resources. In another example of an indication of an allocation of AIoT resources for a specific combination of transmission type followed by reception type, a second DCI type may allocate an AIoT transmission resource to allow transmission of MSG2 of the AIoT random access, followed by reception of one or more (e.g., in different frequencies) MSG3 reception resources. The reader may perform a single transmission of MSG2 on multiple frequencies containing/indicating multiple MSG2 identities, or may perform multiple MSG2 transmissions, each on different frequencies and each indicating different IDs to different devices.

In another example of an indication of an allocation of AIoT resources for a specific combination of transmission type followed by reception type, a third DCI type may allocate an AIoT transmission resource that allows transmission of commands (e.g., by time multiplexing the commands in a single transmission across multiple frequencies) followed by reception of one or more (e.g., in different frequencies) command responses. For example, a DCI type may be used to allocate resources for a read command. Such a DCI type may allocate a larger amount of resources for reception of the data read from the device compared to transmission of the read command itself. In another example, a DCI type may be used to allocate resources for a write command. Such a DCI type may allocate a larger amount of resources for the transmission of the data to be written compared to the reception of the acknowledgement. In an example, the DCI may further signal the behavior and/or role of the reader with respect to an allocated resource. For example, the DCI may explicitly indicate the UE to use the transmission portion of the resource only for transmission and ignore the reception, or vice versa. Alternatively, the DCI may indicate that the reader should perform both transmission and reception.

Example embodiments are directed to dynamic network-triggered transmission. In an example dynamic network-triggered transmission for allocation of resources, a reader may be configured with different resource types (e.g., resource for paging transmission, resource for command transmission, and/or resource for sync transmission). The reader may then perform an AIoT operation (e.g., paging transmission, sync transmission, and/or MSG1 reception) based on a dynamic network trigger that references the resource. In an example, a reader may receive a configuration of a set of resources of a specific type (e.g., MSG2 resources) from the network (e.g., in RRC or SIB). A reader may receive a set of random identities (e.g., in resources configured by the network) and may determine whether to respond in MSG2 based on reception of a trigger message (e.g., DCI trigger, MAC CE trigger) received prior to the configured MSG2 AIoT resources. In another example, a reader may receive a configuration for periodic or repetitive resources for AIoT associated with a particular AIoT transmission/reception type (e.g., sync/occasion transmission, MSG2, and/or command), similar to a configured grant resource on AIoT interface. A reader may determine whether to perform transmission and/or reception of that specific AIoT transmission/reception type (e.g., whether to echo received MSG1, and/or whether to perform sync/occasion signal transmission) when it receives a DCI activating one or more instances of the configured grant resource. The activation message may further contain elements to be included in the contents of the AIoT transmission associated with the enabled configured grant instance.

Example embodiments are directed to resource configuration for an AIoT reader. An AIoT reader may be configured by the network with a set of resources for transmission and/or reception of AIoT signals. Such resources may be time and/or frequency resources for transmission and/or reception of AIoT signals. Transmission and/or reception of AIoT signals may include: transmission of a CW signal; and/or transmission of a paging message. The paging message may indicate any one or more of the following information: one or more device ID or range of device IDs; and/or one or more AIoT resource(s) or resource configurations that allow AIoT devices to perform transmission (e.g., random access, dedicated device transmission). Transmission and/or reception of AIoT signals may further include: transmission of an AIoT synchronization message used for triggering AIoT device transmission; reception of AIoT device transmission, such as random access message transmission (e.g., MSG1, MSG3), device data transmission (i.e. upper layer device ID, command response); transmission of control signaling (e.g., device scheduling information, resource allocation information); and/or reception of device control information (e.g., BSR-like transmission, indication of device energy, desired scheduling time).

In the following example embodiments, are reader may be configured with (semi-)static configuration with resource association. Example embodiments are directed to specific resources being semi-statically associated with a particular purpose of the inventory/command procedure. In an example, a reader may be configured with a static association between a resource and the resource's usage in the inventory procedure. The reader may receive indication of a set of resources (e.g., in an RRC message or SIB) that may be used for transmission and/or reception, where the indicated set resources are identified to be of any of the following example types: transmission of paging message; transmission of sync message; reception of MSG1 (i.e., ID transmission by one or more device ID); transmission of MSG2 (i.e., ID echo of an ID received in MSG1); reception of MSG3 (i.e. upper layer ID or data); transmission of a command message (e.g., read and/or write command); and/or reception of a command response. A transmission of paging message resource type may include, for example, a reader configured with a (set of) resource(s) for paging message transmission. Upon initiation of an inventory procedure, the reader may select among the resources configured for paging message transmission to transmit a paging message. A transmission of sync message (i.e., occasion identification) resource type may include, for example, a reader configured with a (set of) resources for sync transmission. Upon initiation of an inventory procedure, the reader may perform sync transmission in each of the resources for sync transmission for the duration of the inventory procedure. For example, a reader may perform sync transmission in each of (or a subset of selected) sync resources which occur following its paging message transmission. Resources may be identified as being allowable for more than one of the above transmission types. For example, a resource may be identified as being allowable for transmission of paging message or transmission of command. For example, a resource may be identified as being allowable for reception of MSG3 and reception of command response.

Example embodiments are directed to resources for multiple purposes being linked or associated with each other. In an example, a WTRU may be configured with an association between resources associated with different types. For example, a first resource of one type may be associated with a second resource of a second type, either by explicit association (e.g., in the RRC signaling structure) or implicit association (e.g., based on selection by the WTRU). Association of different types of resources may apply for all configured resources (e.g., for all readers) or for a subset of resources, for example to be used by a specific WTRU/reader. For example, one or more resources for reception of MSG1 may be associated with one or more resources for transmission of MSG2. A reader may be configured with resources associated with MSG1 reception and may perform monitoring of such resources based on triggers (e.g., triggers disclosed herein). If a reader successfully receives at least one device transmission in a resource associated with MSG1 reception, the reader may perform MSG2 transmission in a resource associated with the MSG1 resource. In another example, a set of resources for sync transmission may be associated with a paging message transmission resource. A reader may be configured with a set of sync transmission resources and an association of these resources with a paging transmission resource. Upon transmission of a paging message, the reader may perform sync transmission in each of the sync transmission resources associated with the paging transmission resource used for transmission of the paging. In another example, a resource for sync/occasion transmission may be associated with one or more resources for MSG1 reception from multiple devices. A reader may be configured with one or more sync transmission resources. For each sync transmission resources, the reader may derive the associated MSG1 reception resources, either from configuration of the resources themselves (e.g., from the network) based on selection of the sync transmission resource, for example. The reader may further indicate the associated MSG1 transmission resource on the AIoT transmission performed in the sync/occasion message.

Example embodiments are directed to a reader communicating an association to a device in a transmission. A reader may communicate a configured association between two resources (e.g., a transmission resource and a reception resource) in an AIoT transmission. The resources to be configured for a device (e.g., in a reader AIoT transmission) for a response to the AIoT transmission may be determined by the reader using the association with the transmission resource itself. For example, a reader may select a resource for transmission of a sync/occasion signal from the set of resources configured for sync/occasion signal transmission, and/or the reader may receive the resource using dynamic signaling from the network (e.g., DCI). The reader may then determine the set of associated resources for MSG1 transmission from network configuration based on the configured association between the sync/occasion transmission resource and the MSG1 resources. The reader may indicate the resources for MSG1 transmission to the device(s) in a sync/occasion transmission. In another example, a reader may select a resource for transmission of MSG2. A single transmission of MSG2 (e.g., spanning multiple frequencies) may contain multiple echo signals of MSG1 received from different devices. The MSG2 resource may be associated with multiple frequency resources in the reader's RRC configuration, and/or the reader may receive a DCI message indicating the MSG2 resource and/or the corresponding MSG3 resource(s) to be associated with the allocated MSG2 resource for transmission. The reader may then monitor and receive MSG3 transmissions on the associated MSG3 resources.

Example embodiments are directed to a reader determining a subset of configured resources used or restricted for the reader's own transmission or reception. A reader may determine a subset of resources within the configured set of resources that is intended for or can be used for the reader's own transmission/reception. The reader may determine the subset of resources within the configured set of resources for the reader's transmission/reception based on any one or more of the following actions/events: explicit network scheduling; explicit network indication; reader selection (e.g., of the resources for transmission); reception of transmissions and/or energy detected from other reader transmissions; and/or reader identity configured (semi-)statically at the reader. These actions/events are described further in the following. In the case of explicit NW scheduling, for example, a reader may receive a DCI which may explicitly indicate one or more resources or a subset of resources within the resource set that can be used for transmission of a given type. In another example, a reader may receive a DCI which may explicitly indicate to not use one or more resources of a subset of resources within the resource set for transmission of a given type. In the case of explicit network indication, for example, a reader may receive a MAC CE containing an indication (e.g., as a bitmap, as a resource subset index) of the subset of resources within the resource set that can be used for transmission of a given type. In another example, a reader may receive a MAC CE containing an indication (e.g., as a bitmap) of the subset of resources that should not be used for transmission of a given type. In another example, a reader may receive a paging message containing a resource subset (e.g., an index of a subset of resources) that are usable/unusable for AIoT transmission/reception. In another example, SIB may carry the resource index/indices that are usable or restricted for AIoT transmission/reception at a given time. Specifically, a device may check the SIB for the available resources or subset of indices upon triggering an inventory procedure on an available resource subset.

In the case of reader selection (e.g., of the resources for transmission), for example, a reader may select a resource for transmission, which may be one type of AIoT transmission. The selection of resource for transmission may determine the corresponding resources of another type (e.g., resources for reception, resources for other transmission), and may be based on static association (e.g., as described herein). For example, by selecting a specific instance of a transmission resource for MSG2 transmission, the reader may further select an associated resource for reception of MSG3 based on the associated linking or linkage of the resource that may be configured in the resource pool. In the case of reception of transmissions and/or energy detected from other reader transmissions, for example, a reader may monitor transmissions performed by other readers to determine a set of resources (e.g., based on the static association described herein) that the reader is allowed/not allowed to use for the reader's own transmission. The determination of the set of resources for the reader's own transmission may be based on the reader receiving an AIoT transmission (e.g., paging message, sync message) from another reader. The determination of the set of resources for the reader's own transmission may be based on the reader detecting an energy level above a threshold for a specific transmission resource or set of transmission resources. For example, an association of resources of a first type and a second type may be established. If a reader determines another reader has transmitted in the resources of a first type, it may not transmit in any of the associated resources of the second type. For example, if a reader determines another reader has transmitted in resources of a first type, it may receive in the associated resources of the second type. In the case of reader identity configured (semi-)statically at the reader, for example, a reader may be configured (e.g., by the network) with an identity and may derive the resource to select within the pool of resources based on at least on the identity. For example, the reader may select resources from the pool based on the identity modulo the number of readers (e.g., the number of readers may be configured at the reader).

In an example, a reader may receive an explicit indication from the network (e.g., in DCI) providing the resource for a paging message. The reader may further receive (e.g., in the same DCI or in a previous message such as an RRC message), a set of configuration parameters relative to the inventory procedure triggered by the paging message. For example, such configuration parameters may consist of the number of inventory periods (i.e., sync messages) associated with the inventory procedure triggered by the paging message. The reader may determine the resources for the subsequent transmissions and/or reception of the inventory procedure based on the explicit indication and a configured association. For example, the DCI may identify a specific paging resource, while the static association may relate the specific paging resource with a set of subsequent resources for the inventory procedure (e.g., for sync transmission). The reader may perform the sync transmissions in the N sync resources that follow and are associated with the paging resource in the DCI message.

Example embodiments are directed to a reader indicating the selected resource(s) (or a subset of the selected resource(s)) to the network. In an example, when the reader selects an instance of resources to perform a transmission, the reader may indicate the selected resource to the network. A reader may indicate a resource set index to the network, where the index is configured or associated with one or more associated resources (e.g., resource for paging and corresponding resources for sync, such as resource for sync and corresponding resources for MSG1 reception). A reader may send such indication to the network using an uplink message (e.g., RRC message, MAC CE, scheduling request (SR), system information (SI) request procedure, enhanced Uu BSR). For example, a reader in IDLE/INACTIVE state may trigger an SI request procedure to indicate a selected resource of associated set of resources for transmission and/or reception. For example, a reader in INACTIVE state may initiate a resume procedure to indicate the selected resource or resource set to the network. The network may then use this indication to communicate the occupied resources to the other readers and/or indicate to other readers (e.g., via DCI, RRC) of the resources to be monitored by the reader.

In an example, a reader in RRC_CONNECTED state may send a message to the network (e.g., an enhanced Uu BSR, an RRC message, a MAC CE) that may include an indication of the buffer status of the transmission to be performed on AIoT resources (e.g., the size of the data associated with the write command, the size of MSG2 to be transmitted). The message to the network may further include indication of a number of distinct MSG1 random identities received in the MSG1 resources monitored by the reader prior to MSG2 transmission. The message to the network may further include indication of the selected resource (e.g., as a resource index, a timing/frequency index, an SFN number) and/or indication of the start of the resource for transmission of MSG2. The message to the network may further include indication of a selected number (or pattern) of associated MSG3 resources. Such selection may be made, for example, based on other information provided. For example, the number of MSG3 resources selected may be determined from the number of distinct MSG1 random identities received in the monitored MSG1 resources.

Example embodiments are directed to inventory and/or command role determination for a reader. In an example embodiment, a reader may be associated with a role specific to an AIoT procedure. A reader may receive a message (e.g., RRC message, NAS message) that triggers a specific AIoT procedure. Such AIoT procedure may consist of an inventory procedure, and inventory plus command procedure, or a command only procedure. A reader may be associated with a specific role in conjunction with one or more AIoT procedure (e.g., inventory, command). For example, a reader may be configured to be an AIoT reader that performs transmissions only on an AIoT interface. For example, a reader may be configured to be a reader that performs reception only on the AIoT interface. For example, a reader may be configured to perform both transmission and reception associated with an AIoT procedure. A reader's role may be semi-static. For example, the reader may maintain a configured role until it is configured with a different role. In another example, a reader's role may be configured once for any one or more of the following events: an inventory procedure, an inventory occasion (i.e., transmission of an occasion sync message), reception of a command, and/or a device transmission. A reader, depending on its determined role, may perform of transmission only behavior, reception only behavior, or both transmission and reception behavior.

Example embodiments are directed to a reader determining its role. In an example, a reader may determine its role based on resource configuration. For example, a reader may determine its role based on the resources it receives it its configuration. For example, a receive-only reader may receive (only) reception resources. A transmit-only reader may receive (only) transmission resources. A reader that is both transmit and receive may receive transmit and/or receive resources. In another example, a reader may determine its role based on AIoT network scheduling. For example, a reader may determine it is a transmit only reader, or a transmit and receive reader if it is scheduled for transmission on the AIoT resources, which may be a specific type of resource (e.g., paging resource, sync resource). For example, a reader may receive a DCI that schedules transmission of a paging message on a paging transmission resource. The reader that receives the DCI that schedules transmission of a paging message on a paging transmission resource may determine it is transmit-only (e.g., for the duration of an inventory procedure) based on the received DCI message.

In another example, a reader may determine its role based on Uu scheduling. For example, a reader may perform transmit-only or receive-only behavior based on the presence of Uu scheduling that coincides with the timing of specific AIoT resources associated with an AIoT operation (e.g., inventory procedure). For example, a reader may behave as receive-only if it receives Uu scheduling (e.g., for Uu transmission or reception) that overlaps with the configured AIoT transmission resources (e.g., the sync message, the MSG2 echo resources). In another example, a reader may determine its role based on Uu data priority. For example, a reader may perform transmit-only or receive-only behavior based on the priority of Uu data to be transmitted or configured (i.e., established logical channels). For example, a reader may perform receive only behavior if it performs Uu transmission where the scheduled Uu transmission overlaps with an AIoT transmission and the Uu transmission priority is higher than a threshold. In another example, a reader may determine its role based on Reader capability. For example, a reader that is incapable of performing AIoT transmission simultaneously with Uu transmission may use other rules herein to determine whether to perform receive-only behavior. In another example, a reader may determine its role based on Uu RRC state. For example, a reader may determine its behavior based on the configured Uu RRC state. For example, a reader in RRC connected state may perform both transmission and reception behavior, while a reader in RRC IDLE/INACTIVE state may perform receive-only behavior.

In another example, a reader may determine its role based on its CW transmission. For example, a reader configured to perform CW transmission may behave as a reception-only reader. In another example, a reader may determine its role based on signal strength (e.g., reference signal received power (RSRP), received signal strength indicator (RSSI)) of a transmission received from a device. For example, a reader may determine whether to perform transmission-only or reception-only behavior based on the signal strength of one or more received device transmissions. For example, in reference to the transmission-only and reception-only behavior with respect to MSG1 and MSG2, a reader may determine to respond to MSG1 reception using MSG2 (i.e., echo the received random ID on AIoT interface), if the signal strength of the received MSG1 is above a threshold. For example, if the signal strength of one or more (e.g., at least one, at least x configured, all) received MSG1s on the MSG1 AIoT resources configured to the reader are above a threshold, the reader may respond with MSG2 on the AIoT resources using MSG2 resources. For example, if the signal strength of none or one or more (e.g., at least one, at least x configured, all) received MSG1 on AIoT resources received by the reader is below a threshold, the reader may report the received MSG1 identities (e.g., those above the threshold or those below the threshold) to the network. In another example, a reader may determine its role based on measurements (e.g., interference power). For example, a reader may determine to perform transmission-only behavior if the power of interference (e.g., from devices associated with another reader, from reader(s) not associated or not paired with this reader) is above a threshold.

Example embodiments are directed to reception-only behavior of a reader. A reception-only reader may perform any of the following behavior with regard to MSG1 reception, MSG3 reception, and/or device ID reporting. In an example of MSG1 reception, a reception-only reader may monitor a set of resources for MSG1 transmission by multiple devices. The reader may receive the resource(s) (e.g., timing, frequenc(ies)) for performing the MSG1 reception from the network as described herein. Following the monitoring of all configured MSG1 resources, and upon successful reception of MSG1 (e.g., a random number) from at least one AIoT device, the reader may trigger a report to the network. The report to the network may include for example any one or more of the following information: the received random number(s); the received signal power/energy on the MSG1 resource; the timing/frequency of the resource(s) in which MSG1 was received by the reader; any additional information provided by the device along with MSG1 (e.g., an AIoT control message, available device energy, AIoT-specific BSR). In an example, the reader may send an UL RRC message as a reporting message to the network and may include any of the information following monitoring of the configured MSG1 resources.

In an example of MSG3 reception, a reception-only reader may perform monitoring of a set of MSG3 resources. The reader may perform such monitoring in the case where it previously reported at least one random number to the network following MSG1 reception. In an example, the reader may perform such monitoring in case of reception of a trigger message from the network (e.g., an RRC message, a DCI, a MAC CE activating reception). The reader may receive the resource(s) (e.g., timing, frequencies) for performing MSG3 reception from the network as described herein. In an example, the reader may derive the resources based on a configured association with the previous MSG1 reception resources, as described herein. In an example of device ID reporting, upon successful reception of MSG3 from at least one AIoT device on the MSG3 resources, the reception-only reader may report the set of all device IDs received in MSG3 to the network (e.g., by transmitting an UL RRC message including indications of the set all device IDs received in MSG3).

Example embodiments are directed to transmission-only behavior of a reader. A transmission-only reader may perform any of the following behavior with regard to transmission-only behavior: AIoT paging transmission, AIoT sync transmission, MSG2 transmission, and/or subsequent message transmission (e.g., acknowledgement (ACK) message, command message). In an example of AIoT paging transmission, a transmission-only reader may transmit an AIoT paging message in a paging resource that is configured and/or indicated by the network. The reader may indicate in the AIoT paging message a set of IDs provided by upper layers (e.g., core network) and/or provided by the gNB in the AIoT paging message. The reader may indicate in the AIoT paging message a value of the number of occasions, either selected by the reader itself, or configured by the network. In an example of AIoT sync transmission, a transmission-only reader may transmit an AIoT sync/occasion message. The transmission of the sync/occasion message may be triggered by the network based on a network indication (e.g., in an RRC message, DCI, change of system information, MAC CE). The transmission-only reader may determine the resources for transmission of the sync/occasion message based on configuration, or included in the trigger provided by the network.

In an example of a MSG2 transmission, a transmission-only reader may transmit MSG2 based on random identities received from the network. For example, the transmission-only reader may receive a list of random identities from the network. In another example, the transmission-only reader may receive a single bitmap of the random identities that may have responded. The reader may receive the list of random identities (e.g., in an RRC message, DCI, MAC CE) and may receive along with the list the resources for MSG2 transmission and/or with the trigger for performing the MSG2 transmission. In another example, the reader may determine the resource for transmission of MSG2 based on configuration and/or association, as described herein. Upon reception of the list of random identities from the network, the reader may include the random identities received from the network into the AIoT MSG2 transmission. In an example of subsequent message transmission (ACK, command), a transmission-only reader may be instructed to transmit a subsequent message by the network. For example, a reader that has received a command from the upper layers (e.g., CN) may be instructed to transmit the command on the AIoT interface from the network (using a trigger by the network such as those described herein). For example, the network may indicate to a specific reader whether or not to transmit an acknowledgement in response to reception of MSG3 data on the AIoT interface, along with the AIoT resources to do so.

Example embodiments are directed to transmission and reception behavior of a reader. A reader may be configured with both transmission and reception behavior. In addition to any of the behavior of the transmission-only and reception-only readers, a reader may perform any one or more of the following example behaviors. In an example behavior, the reader may determine the contents of MSG2 transmission based on the received MSG1 random identities. In another example behavior, the reader may determine the contents of MSG2 transmission based on both the contents of the received MSG1 random identities (from reception on MSG1 resources and from the network). For example, MSG2 may contain the union of the random identities received both from the devices (in MSG1 reception) and the network (e.g., in RRC). In another example, MSG2 may contain the intersection of the random identities received both from the devices (in MSG1 reception) and the network (e.g., in RRC). In another example, MSG2 may contain the random identities confirmed by the network following report of the received random identities reported by the reader to the network.

Example embodiments are directed to synchronizing multiple transmissions from different readers at the device. A transmission-only reader may be configured (or may determine) a session ID or session number associated with an AIoT operation. For example, upon initiation of an inventory procedure (e.g., based on a network trigger), the transmission-only reader may receive a session identity from the network. The reader may include the session ID in its transmission (e.g., in the paging message, sync/occasion message). A transmission-only reader may include a unique reader ID in the message. For example, the transmission-only reader may receive an identity from the network and may include it in the message. An AIoT device may use the received session ID to identify multiple redundant operations being performed by different readers. For example, upon reception of multiple paging messages with the same session ID, the device may configure its random access procedure based on the parameters configured in only one of the received paging messages (e.g., the paging message with the highest received power or the first paging message received). In another example, upon reception of multiple paging messages with the same session ID, the device may update its random access procedure configuration parameters to use a second set of parameters if it is different from the first set of parameters received from a previous paging message with the same session ID.

In an example, upon reception of multiple sync/occasions messages with the same session ID, the device may perform random access using only one of the readers. For example, the device may transmit MSG1 of the random access procedure in the resources indicated by only one of the readers. The device may be configured with rules for selecting the reader such as any one or more of the following example rules: the first reader that transmitted the paging message; the reader with the best paging message measured quality; and/or the reader the device last responded to, or responded to most often in the past. According to an example embodiment, a WTRU may determine whether to be a transmitting reader and/or receiving reader in a joint inventory procedure performed on a set of configured resources based on network scheduling. The WTRU may transmit/receive the random access step results to/from the network. A WTRU (e.g., an intermediate WTRU 406 in topology 400B of FIB. 4B) may receive an inventory and/or command request from the CN (e.g., via a network node such as a gNB) via an upper layer message (e.g., NAS) that contains a set of device IDs. The WTRU may determine a set of inventory parameters (e.g., number of access rounds Q, device ID(s)) based on the received upper layer message. For example, an intermediate WTRU (reader) may be (pre)configured with inventory parameters to use for each range of the number of device IDs in the inventory request. The WTRU may report the inventory parameters to the gNB (e.g. using an RRC message). The WTRU may receive indication of an AIoT resource pool (e.g., a set of associated resources for transmission and reception of AIoT signals/messages indicated in terms of time and/or frequency) (e.g., in an RRC message) that indicates a specific set of resources and a linkage between such resources. The linkage of the resources may be for any one or more of the following transmission types: transmission of control (e.g., paging, occasion sync); an associated reception of MSG1 (random ID); an associated transmission of MSG2 (echo random ID); and/or an associated reception of device data. The WTRU may determine whether to be a transmitting WTRU based on one or more of: network configuration, dedicated DCI, and/or Uu traffic. For example, the WTRU may be configured as a transmitting WTRU when receiving transmission resources in the resource pool. In another example, the WTRU may receive an indication from the network (e.g., DCI) prior to the configured transmission resources. In another example, the WTRU may not have Uu transmissions that overlap with any transmission resources in the received resource pool.

If the WTRU determines that it is a transmitting WTRU, then the WTRU may transmit the inventory parameters (e.g., device ID, Q) and the occasion sync on the resource for transmission of control. If the WTRU determines that it is a receiving-only WTRU, then the WTRU may perform monitoring of AIoT transmissions on the resources associated with MSG1 reception. Upon reception of one or more ID(s) on the resources for MSG1 reception, or reception of an ID from the network (e.g., in DCI containing the ID), a WTRU that is a transmitting WTRU may transmit the received random ID on the associated resource for transmission of MSG2. Upon reception of one or more ID(s) on the resources for MSG1 reception, or reception of an ID from the network (e.g., in DCI containing the ID), a WTRU that is a receiving-only WTRU may send the received ID to the network (e.g., using an SR and/or BSR). The WTRU that is a receiving-only WTRU may perform reception of the application device ID on the associated resource for device ID reception. When completing the monitoring on all reception resources of the resource pool, the WTRU that is a receiving-only WTRU may send a report to the network with the received device data in MSG3 (e.g., containing device ID, AIoT received power, carrier frequency, carrier characteristics).

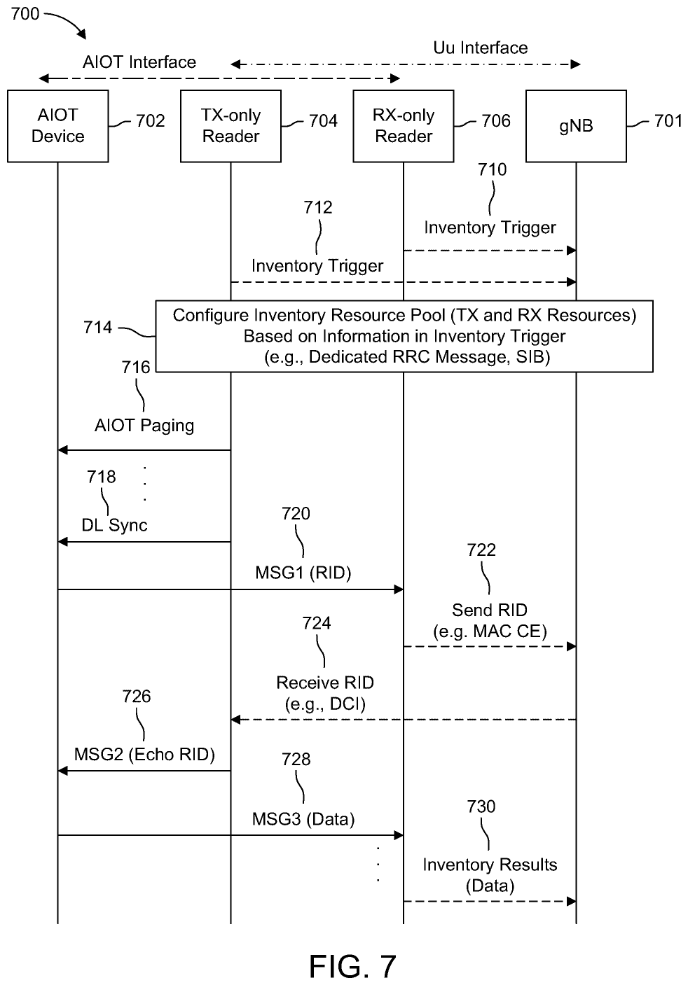

FIG. 7 is a signaling diagram illustrating an example inventory procedure 700 involving multiple readers. Communications on the AIoT interface (between readers and devices) are represented by solid arrows, and communications on the Uu interface (between the readers and the network) are represented by dashed arrows. According to the example topology for the example inventory procedure 700, AIoT device 702 communicates via transmission-only reader 704 and reception-only reader 706 (acting as intermediate nodes) in order to communicate with gNB 701. Transmission-only reader 704 may send an inventory trigger message 712 to gNB 701 to initiate the inventory procedure 700, and/or reception-only reader 706 may send an inventory trigger message 710 to gNB 701 to initiate the inventory procedure 700. Sending of inventory trigger messages 710 and/or 712 may be triggered by upper layers (e.g., following reception of a CN message or a CN paging at the device). The inventory trigger message 710/712 send to the gNB 701 may serve as a request to configure resources for the inventory procedure 700. In particular, at 714, the configuration of the inventory resource pool (including transmission resources and reception resources) may be performed (e.g., via SIB and/or RRC signaling) between the reader(s) 704, 706 and the gNB 701 (network). As part of the configuration of the inventory resource pool at 714, each reader 704, 706 may use configuration information from the network to determine whether it is a transmission-only reader or a reception-only reader.

The transmission-only reader 704 may transmit the AIoT paging message 716 to the AIoT device 702, and may transmit one or more DL sync message(s) 718 to the AIoT device 702. The reception-only reader may receive MSG1 720 (including a random ID) from the AIoT device 702 that was triggered by the AIoT paging message 716. The reception-only reader 706 may send the random ID received from the device 702 to the gNB 701 (network) in a message 722 (e.g., MAC CE) so the network may provide the random ID to the transmission-only reader 704 in message 724 (e.g., DCI). The transmission-only reader 704 may transmit the random ID in MSG2 726 over the AIoT interface to AIoT device 702. After the device 702 receives MSG2 726, the device 702 may transmit the AIoT data in MSG3 728, which is received by the reception-only reader 706. The reception-only reader 706 forwards the received data in an inventory results message 730 to the gNB 701 (network).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A wireless transmit/receive unit (WTRU) comprising:
a transceiver; and
a processor, wherein the transceiver and the processor are configured to:
receive, from a network node, a request message comprising a set of device identifications (IDs), wherein the request message is one of an inventory request message and a command request message;
send, to the network node, a report message comprising information indicating inventory parameters;
receive, from the network node, an indication of an AIoT resource pool comprising information indicating time-frequency resources for transmission of ambient Internet-of-things (AIoT) signals and time-frequency resources for reception of AIoT signals and a linkage between the time-frequency resources for the transmission of the AIoT signals and the time-frequency resources for the reception of the AIoT signals; and
on a condition that the WTRU is configured to be a transmitting WTRU:
transmit, to an AIoT device, the information indicating the inventory parameters using at least one resource from the indicated time-frequency resources for the transmission of AIoT signals;
transmit, to the AIoT device, an occasion synchronization message using the at least one resource from the indicated time-frequency resources for the transmission of AIoT signals; and
receive, from the AIoT device, a message indicating a random identification (ID) for the AIoT device using at least one resource from the indicated time-frequency resources for the reception of AIoT signals that is linked to the at least one resource from the indicated time-frequency resources for transmission of AIoT signals according to the indicated linkage between the time-frequency resources for the transmission of the AIoT signals and the time-frequency resources for the reception of the AIoT signals.

2. The WTRU of claim 1, wherein the WTRU is configured with the inventory parameters according to a range of a number of device IDs indicated in the set of device IDs.

3. The WTRU of claim 1, wherein the linkage between the time-frequency resources for the transmission of the AIoT signals and the time-frequency resources for the reception of the AIoT signals is for each of the following: transmission of control information including paging messages and occasion synchronization messages; reception of a MSG1 message indicating a random identification (ID); transmission of a MSG2 message echoing the indicated random ID; and reception of a MSG3 message comprising data for the AIoT device.

4. The WTRU of claim 1, wherein the WTRU determines that the WTRU is configured to be a transmitting WTRU based on at least one of the following factors: network configuration, downlink control information (DCI), or Uu traffic.

5. The WTRU of claim 1, wherein the WTRU determines that the WTRU is configured to be a transmitting WTRU based on the indicated AIoT resource pool.

6. The WTRU of claim 1, wherein the transceiver and the processor are further configured to:
on a condition that the WTRU is configured to be a receiving-only WTRU:
monitor for AIoT transmissions from one or more AIoT devices using one or more of the indicated time-frequency resources for the reception of AIoT signals.

7. The WTRU of claim 1, wherein the received message indicating the random ID is a MSG1 message.

8. The WTRU of claim 1, wherein the indicated inventory parameters includes an indication of a number of access rounds and a device ID associated with the AIoT device.

9. The WTRU of claim 1 configured as an intermediate node.

10. The WTRU of claim 1 configured as a radio frequency identification (RFID) reader, and wherein the AIoT device comprises an RFID tag.

11. A method performed by a wireless transmit/receive unit (WTRU) comprising:
receive, from a network node, a request message comprising a set of device identifications (IDs), wherein the request message is one of an inventory request message and a command request message;
send, to the network node, a report message comprising information indicating inventory parameters;
receive, from the network node, an indication of an AIoT resource pool comprising information indicating time-frequency resources for transmission of ambient Internet-of-things (AIoT) signals and time-frequency resources for the reception of AIoT signals and a linkage between the time-frequency resources for the transmission of the AIoT signals and the time-frequency resources for the reception of the AIoT signals; and
on a condition that the WTRU is configured to be a transmitting WTRU:
transmit, to an AIoT device, the information indicating the inventory parameters using at least one resource from the indicated time-frequency resources for the transmission of AIoT signals;
transmit, to the AIoT device, an occasion synchronization message using the at least one resource from the indicated time-frequency resources for the transmission of AIoT signals; and
receive, from the AioT device, a message indicating a random identification (ID) for the AioT device using at least one resource from the indicated time-frequency resources for the reception of AioT signals that is linked to the at least one resource from the indicated time-frequency resources for the transmission of AIoT signals according to the indicated linkage between the time-frequency resources for the transmission of the AIoT signals and the time-frequency resources for the reception of the AIoT signals.

12. The method of claim 11, wherein the WTRU is configured with the inventory parameters according to a range of a number of device IDs indicated in the set of device IDs.

13. The method of claim 11, wherein the linkage between the time-frequency resources for the transmission of the AIoT signals and the time-frequency resources for the reception of the AIoT signals is for each of the following: transmission of control information including paging messages and occasion synchronization messages; reception of a MSG1 message indicating a random identification (ID); transmission of a MSG2 message echoing the indicated random ID; and reception of a MSG3 message comprising data for the AIoT device.

14. The method of claim 11, wherein the WTRU determines that the WTRU is configured to be a transmitting WTRU based on at least one of the following factors: network configuration, downlink control information (DCI), or Uu traffic.

15. The method of claim 11 wherein the WTRU determines that the WTRU is configured to be a transmitting WTRU based on the indicated AIoT resource pool.

16. The method of claim 11, further comprising:
on a condition that the WTRU is configured to be a receiving-only WTRU:
monitoring for AIoT transmissions from one or more AIoT devices using one or more of the indicated time-frequency resources for the reception of AIoT signals.

17. The method of claim 11, wherein the received message indicating the random ID is a MSG1 message.

18. The method of claim 11, wherein the indicated inventory parameters includes an indication of a number of access rounds and a device ID associated with the AIoT device.

19. The method of claim 11, wherein the WTRU is configured as an intermediate node.

20. The method of claim 11 wherein the WTRU is configured as a radio frequency identification (RFID) reader, and wherein the AIoT device comprises an RFID tag.
